(19) United States
(12) Patent Application Publication
(10) Pub. No.: US 2005/0251429 A1
(43) Pub. Date: Nov. 10, 2005

(54) Health care claim status transaction system and method

(75) Inventors: Mary J. Ammer, Roseville, MN (US); Shannon W. Bator, Brighton, MA (US); Rachana S. Gray, Malden, MA (US); Christine Hagar, Braintree, MA (US); Dawn M. Nee, South Walpole, MA (US); Cari-Ann Verge, Mansfield, MA (US)

Correspondence Address: DOWNS RACHLIN MARTIN PLLC, 199 MAIN STREET, P O BOX 190, BURLINGTON, VT, 05402-0190, US

(73) Assignee: IDX Investment Corporation, Burlington, VT (US)

(21) Appl. No.: 10/925,420

(22) Filed: Aug. 25, 2004

Related U.S. Application Data
(60) Provisional application No. 60/568,081, filed on May 4, 2004.
(60) Provisional application No. 60/570,667, filed on May 13, 2004.

(51) Int. Cl. G06F 17/60

(52) U.S. Cl. 705/4

(57) ABSTRACT

A system (200) and method (400) for automatically handling health care claim status requests (228) and responses (232). The system includes a health care software application (246) that provides patient invoice functionality relating to health care claims submitted to various payers (216), e.g., insurance companies. A claim status transaction software module (258) includes a routing software sub-module (282) that intelligently routes responses received from payers within the system so that a variety of follow-up activities may be performed. The routing software sub-module routes the responses as a function of information contained in the responses. The system also includes a pre-checking software sub-module (272) that performs a variety of checks on each claim status request prior to the system sending that request. If a request fails a pre-check, the response can be automatically placed onto a follow-up list (296) for follow up.

### RELATED APPLICATION DATA

This application claims the benefit of priority of U.S. Provisional Patent Application Ser. No. 60/568,081, filed May 4, 2004, and U.S. Provisional Patent Application Ser. No. 60/570,667, filed May 13, 2004, both titled “Health Care Claim Status Transaction System and Method” both of which are incorporated by reference herein in their entireties.

### FIELD OF THE INVENTION

The present invention generally relates to the field of electronic transaction systems. In particular, the present invention is directed to a health care claim status transaction system and method.

### BACKGROUND OF THE INVENTION

A vast majority of bills for patient health care services are presently paid by institutional payers, e.g., insurance companies, health care maintenance organizations, privately insured groups and government agencies, among others. These bills are typically handled by a health care provider, e.g., a physician, hospital, integrated health care network, long-term care provider, or other provider, and occasionally the covered patient, submitting a heath care claim to a payer for payout or reimbursement for the services provided by the health care provider. Consequently, health care providers and payers process an overwhelming number of claims each year.

Not infrequently, health care providers must check the status of the claims they have submitted to the payers for a variety of reasons, such as a certain amount of time has passed without payment or to simply ensure that the claim is being processed appropriately, among others. Presently, the typical process that a health care provider follows for submitting and checking the status of a claim is as follows. First, charges for the service(s) provided to a patient are entered into the patient's account using, e.g., billing/claims software application. Examples of conventional billing/claims applications include the billing and accounts receivable (BAR), hospital patient administration (HPA) and paperless collections system (PCS) applications available as part of FLOWCAST™ software licensed by IDX Systems, Burlington, Vt. After the charges and any accompanying information have been entered, the billing/claims application generates a claim, which the provider then submits to the corresponding payer via paper, data storage tape or electronic data interchange (EDI), among other modes. Regarding EDI, EDI often comprises a number of standards developed by the Accredited Standards Committee (ASC) of the American National Standards Institute (ANSI) to standardize the format of data transmitted over a computer network, such as the Internet. These standards are known as the “X12 standards.”

After the health care provider has submitted a claim, it may be necessary for the provider to check the status of the claim. This process is typically handled by the health care provider's claims follow-up staff, which will first review the history of the patient's account for information relating to the claim submitted. The follow-up staff will then follow up with the patient's payer by requesting the status of the claim. This is typically done by telephoning the payer or accessing the payer's claim-processing system via an automated line or the payer's website. In any case, the follow-up staff must work outside the billing/claims application, either by phone or a software application, e.g., a web browser, other than the billing claims application to make the status inquiry.

In response to the follow-up staff's request, the payer typically provides the follow-up staff with the status of the claim at issue, e.g., whether the claim was paid, rejected, being processed or not yet received, among others. If the payer paid the claim, the payer will typically provide the follow-up staff with information relating to the payment, such as the payment date, check number and name of the payee. If the payer did not yet pay the claim, the payer will typically provide a reason why the claim was not paid. The follow-up staff will then re-access the billing/claims application and update the patient's account with information regarding the status of the claim. In addition, depending upon the status of the claim, the follow-up staff may also need to update patient information and resubmit the claim, supply the payer with additional information and resubmit the claim or write-off the claims.

This conventional manner of handling health care claim status requests and responses requires a relatively large amount of human involvement in the various steps of the process, as well as relatively cumbersome need to switch back and forth between software applications to perform the various steps of the process. What is needed is a system that largely, or entirely, automates handling of claim status requests and responses so as to reduce the level of human involvement and streamline the workflow of handling these requests and responses.

### SUMMARY OF THE INVENTION

In one aspect, the present invention is directed to a method of automatically handling a claim status transaction. The method comprises the steps of receiving an electronic claim status response containing information relating to status of a claim and electronically routing the electronic claim status response as a function of the information.

In another aspect, the present invention is directed to a method of automatically handling a claim status transaction. The method comprises the step of assembling an electronic claim status request for a claim. At least one check is performed on the electronic claim status request and it is determined if the electronic claim status request passes or fails the at least one check. If the electronic claim status request fails the at least one check, a claim status transaction category is assigned to the electronic claim status request.

In a further aspect, the present invention is directed to a system comprising at least one computer containing a health care software application that provides a user with patient invoice functionality relating to at least one health care claim. The computer further contains a claim status transaction software module operatively configured to interface with the health care application. The claim status transaction software module comprises a first set of computer instructions for receiving an electronic health care claim status response containing information relating to status of the at least one health care claim. The claims status transaction software module also comprises a second set of computer instructions for electronically routing the electronic health care claim status response as a function of the information.

### BRIEF DESCRIPTION OF THE DRAWINGS

For the purpose of illustrating the invention, the drawings show a form of the invention that is presently preferred. However, it should be understood that the present invention is not limited to the precise arrangements and instrumentalities shown in the drawings, wherein:

FIG. 1 is a high-level diagram of workflow using an automated claim status transaction system of the present invention;

FIG. 2 is a high-level schematic diagram of an automated claim status transaction system of the present invention;

FIG. 3A-3D are a series of screenshots of screens that may be provided by a health care software application suitable for use with the claim status transaction system of FIG. 2, illustrating a path a user may take in order to access claim status transaction functionality of the present invention;

FIG. 3E is a screenshot of a waiting mode screen that the claim status transaction system of the present invention may present to a user while a claim status transaction is being processed in real time;

FIG. 3F is a screenshot of a claim status results screen illustrating various information regarding a claim status check that a user may desire to view;

FIG. 3G is a screenshot of a setup screen for setting up information for each trading partner with which the claim status transaction system of FIG. 2 may interact;

FIG. 3H is a screenshot illustrating a popup window that may be presented to a user by the claim status transaction system of FIG. 2 during pre-checking of a claim status request prior to claim status transaction system sending the request;

FIG. 3I is a screenshot illustrating another popup window that may be presented to a user by the claim status transaction system of FIG. 2 during pre-checking of a claim status request prior to claim status transaction system sending the request;

FIG. 3J is a screenshot of an interface screen for modifying the claim status transaction system category field of the claim status transaction system of FIG. 2;

FIG. 3K is a screenshot of a dictionary interface screen for adding or modify information in a claim status grouping dictionary of the claim status transaction system of FIG. 2;

FIG. 3L is a screenshot illustrating a popup window that may be presented to a user by the claim status transaction system of FIG. 2 when a user seeks to display information regarding past claim status requests but the system has not yet initiated any such requests;

FIG. 3M is a screenshot of a claim status detail screen that the claim status transaction system of FIG. 2 may display when a user requests to view the history of claim status requests for a particular patient invoice;

FIG. 3N is a screenshot of an interface screen for modifying the claim status transaction system category field in a response category dictionary of the claim status transaction system of FIG. 2;

FIG. 3O is a screenshot of an interface screen for modifying the claim status transaction system category field in a response code dictionary of the claim status transaction system of FIG. 3;

FIGS. 4A-4C show a flow diagram for a method of processing electronic claim status requests and responses that may be implemented on the automated claim status transaction system of FIG. 2; and

FIG. 5 is a high level schematic diagram of a computer system containing a claim status transaction system of the present invention.

### DETAILED DESCRIPTION OF THE DRAWINGS

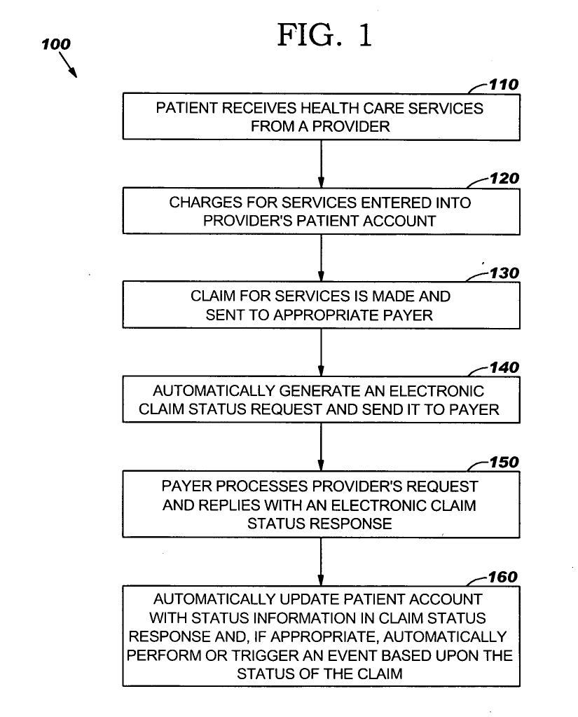

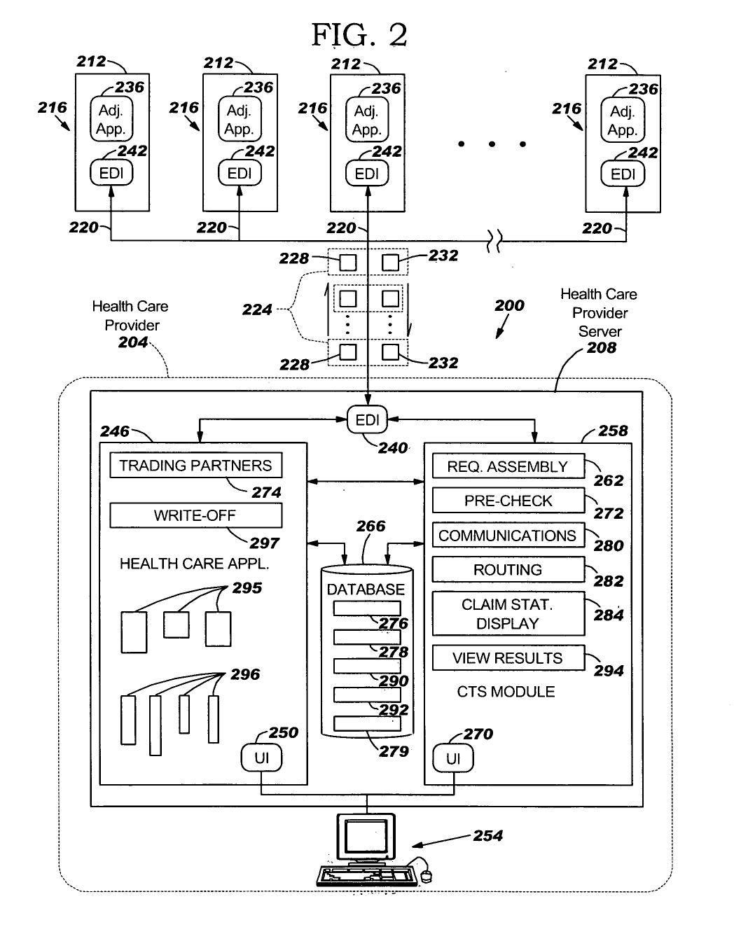

Referring now to the drawings, FIG. 1 is a workflow diagram 100 illustrating a workflow scenario for handling claim status requests and responses using an automated claim status transaction (CST) system of the present invention. One embodiment of the CST system is described below in detail in connection with FIGS. 2-5. Workflow diagram 100 gives the reader a broad overview of the functionality that a CST system of the present invention can provide. At step 110, a health care recipient, e.g., a patient, receives services from a health care provider, e.g., physician, hospital, integrated health care network, long-term care provider, or other provider. At step 120, billing staff personnel of the provider enters the charges, description of the services provided and/or other needed information into a patient account corresponding to that patient using, e.g., a billing/claims application. The claim is queued and, at step 130, is sent to payer in any conventional manner, such as via paper, digital data storage tape or other medium or EDI, among others.

After the health care provider has submitted the claim, it may be necessary to check the status of the claim. Entities requesting health care claim status may include, but not be limited to, hospitals, nursing homes, laboratories, physicians, allied professional groups, employers and supplemental health care claims adjudication processors. Scenarios in which a user may desire to check the status of a claim include a scenario in which the user is viewing or performing claims follow-up actions and needs to know the status of a claim that has not yet been paid. Another scenario is one in which the user receives a call about a patient account and needs to view the details of a claim's status while the caller remains on the line. When it is desired to learn the status of a claim, at step 140 a user, e.g., claims follow-up staff, may initiate a claim status request procedure that automatically assembles and sends an electronic request to the appropriate payer. Generally, the electronic request contains the necessary information that identifies the claim at issue so that the payer may formulate an appropriate reply, preferably electronically and in real-time.

At step 150, the payer may reply to the electronic request with an appropriate electronic response that conveys the status information for that claim to the CST system. After the CST system receives the electronic response, at step 160 the CST system may automatically store the response and/or update the patient account with information regarding the status of the claim based upon information contained in the response and/or information concerning the original requested, e.g., whether or not the request was sent and a response was received, among others. In addition, depending upon the status of the claim, the CST system may perform and/or trigger various automated events, such as re-queuing the claim request (e.g., if the electronic response indicates that the payer has not yet adjudicated the claim), writing off the claim (e.g., if the electronic response indicates that the payer has rejected the claim) or adding the claim to a follow-up list (e.g., if the electronic response indicates that the electronic requests contained missing or incorrect information that prevented the payer from adjudicating the claims), among other actions.

Some benefits that a CST system of the present invention can provide flow from the partial to complete automation of the claim follow-up process. Using a CST system of the present invention will no longer require users to perform a manual inquiry on each claim that is outstanding to a payer. In addition, a CST system of the present invention can allow a user to queue-up and process a number of requests; the user does not need to do something for each individual claim. Rather, the user can perform work on only the problem area claims. Automated processing of electronic transactions can also provide the benefit that the user does not need to access claim status information from a website or by calling a payer. These conventional approaches to claim status inquiry can be very costly to the inquiring entity due to the users being on hold to the payers or the switching back and forth between software applications. Furthermore, when a CST system of the present invention implements claims status requests and responses in accordance with the 276/277 transaction set EDI standard (discussed below), inquiring entities can become compliant with requirements under the Health Insurance Portability and Accountability Act (HIPAA) of 1996. These and other benefits of a CST system of the present invention will become apparent upon reading of the disclosure below.

It is noted that workflow diagram 100 illustrates only some of the features of a CST system of the present invention and, more particularly, some of the features relating to a successfully sent and received request and a successfully sent and received response. As will become apparent from the below description of one embodiment of the present invention, a CST system of the present invention may include numerous other features, including various error-checking features for handling various errors relating to the sending of an automated request. Many of these features are described below.

FIG. 2 shows an exemplary CST system 200 of the present invention that may be used, e.g., by a health care provider 204 to enable the workflow illustrated by workflow diagram 100 of FIG. 1. In FIG. 2, CST system 200 is shown as being implemented on a provider server 208 and linked to a plurality of payer servers 212, each corresponding to a distinct payer 216 that insures or otherwise covers at least some of the health care costs of one or more patients. Each payer server 212 may communicate with provider server 208 via a corresponding respective communications link 220, which may be an open link (preferred), e.g., an Internet link that may be used practically any time, or a temporary link, such as a dial-up link, among others. Each payer 216 may be any one of a number of organizations, such as a commercial insurance company, a health care maintenance organization, a clearinghouse or a government agency, among others. While multiple payers 216 are shown to reflect the most common scenario, those skilled in the art will understand that CST system 200 may be linked to the payer server 212 of only one payer 216. Such an arrangement may be appropriate, e.g., within a vertically integrated health care delivery system. Generally, the only requirement for implementing CST system 200 is that each payer 216 be capable of handling electronic claim transaction sets 224, i.e., receiving electronic claim status requests 228, processing these requests and sending electronic claim status responses 232.

Electronic claim status requests 228 and responses 232 may have any data format desired. However, practically speaking, due to U.S. laws relating to HIPAA, health care providers and payers in the U.S. implementing electronic claim status transaction features in their computer systems must utilize certain EDI standards for these transactions promulgated by subcommittee X12N of the ASC mentioned above in the background section. More particularly, the relevant X12N standards for electronic claim status requests 228 and responses 232 are, respectively, the ANSI ASC X12.316 Health Care Claim Status Request (a/k/a a “276 transaction”) standard and the ANSI ASC X12.317 Health Care Claim Status Response (a/k/a a “277 transaction”) standard. Together, the 276 and 277 transactions are commonly referred to as a “276/277 transaction set.” Details regarding the format and implementation of the 276/277 transaction set may be found in the National Electronic Data Interchange Transaction Set Implementation Guide—Health Care Claim Status Request And Response, 276/277, ASC X12N 276/277 (004010X093), published by Washington Publishing Company (www.wpc-edi.com), which is incorporated by reference herein in its entirety. For convenience, the present invention is described with only occasional reference to the 276/277 transaction set. However, those skilled in the art will readily understand how to implement the present invention using all of the 276/277 transaction set standards so as to be HIPAA compliant.

To facilitate communications between CST system 200 and each adjudication application 236, provider server 208 and each corresponding respective payer server 212 may include a respective EDI interface 240, 242. If the 276/277 transaction set is used for electronic requests 228 and responses 232, each EDI interface 240, 242 would be configured for handling these transactions. If electronic requests 228 and responses 232 conform to another standard, each EDI interface 240, 242 would be configured for implementing that standard. In other implementations, EDI interfaces 240, 242 may not be necessary at all. This may be the case, e.g., if a payer 216 and provider 204 are part of a vertically integrated health care delivery system.

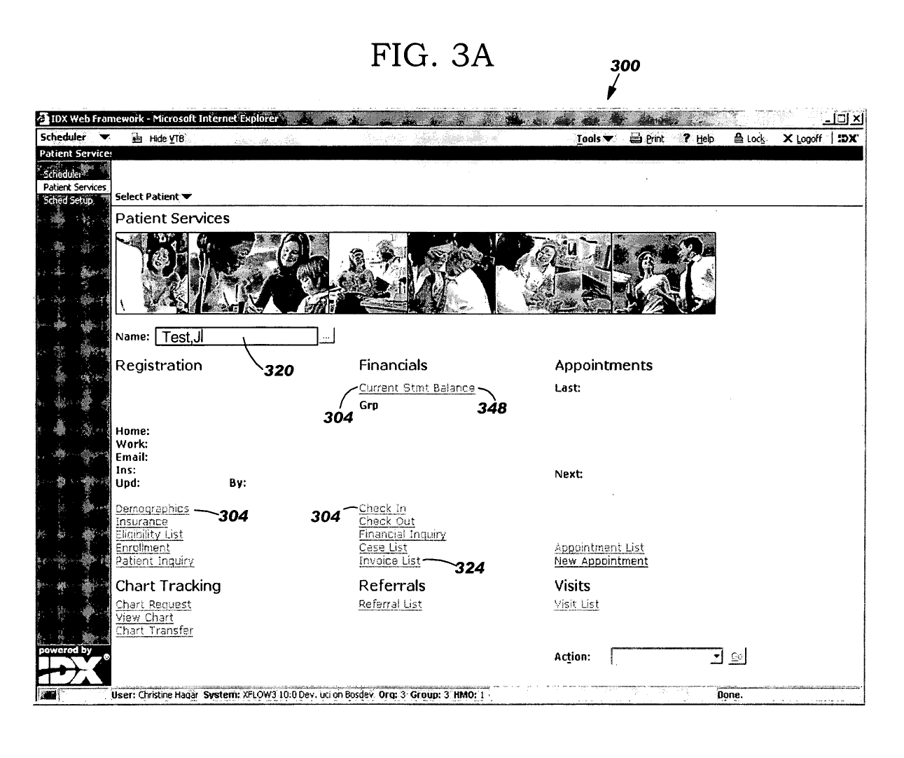

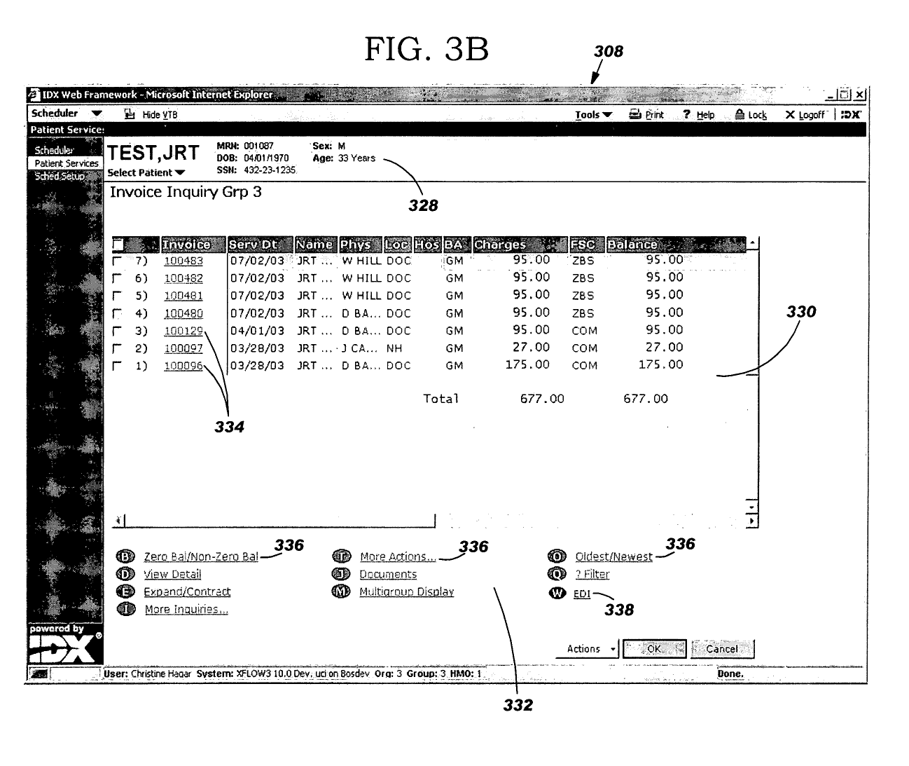

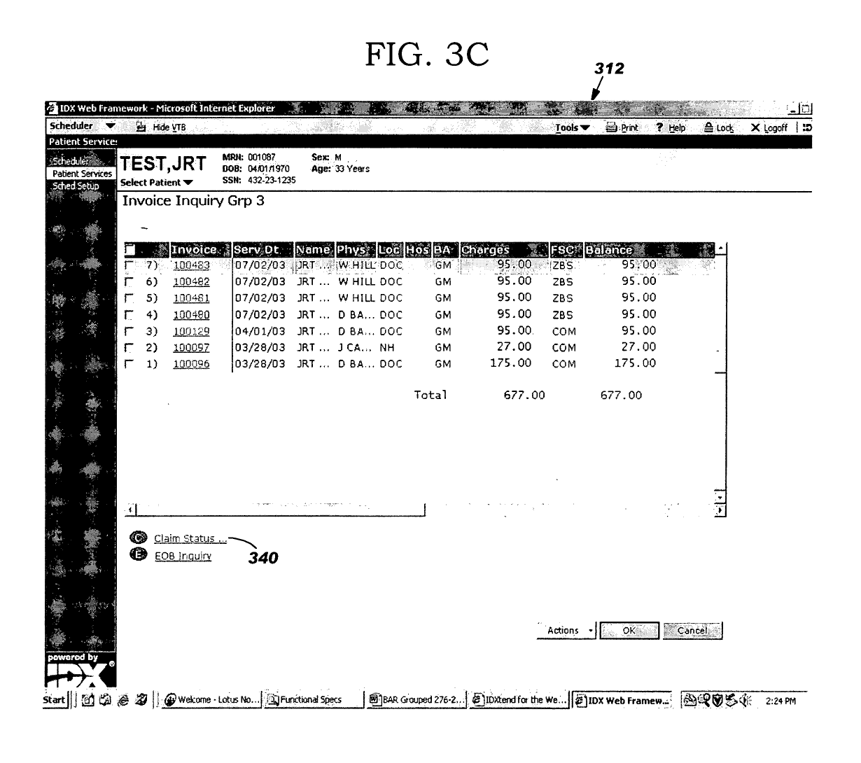

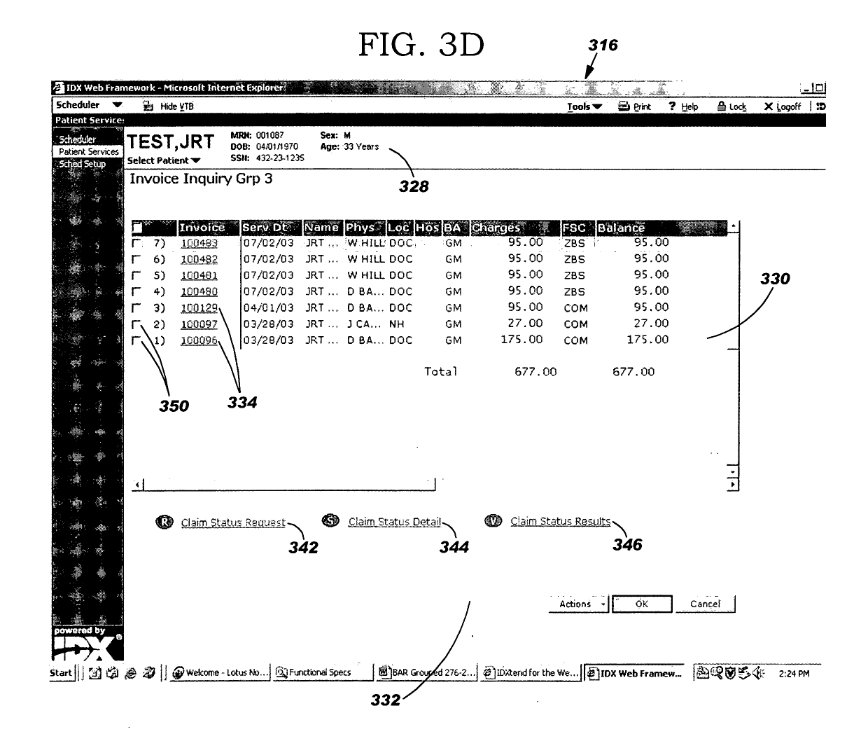

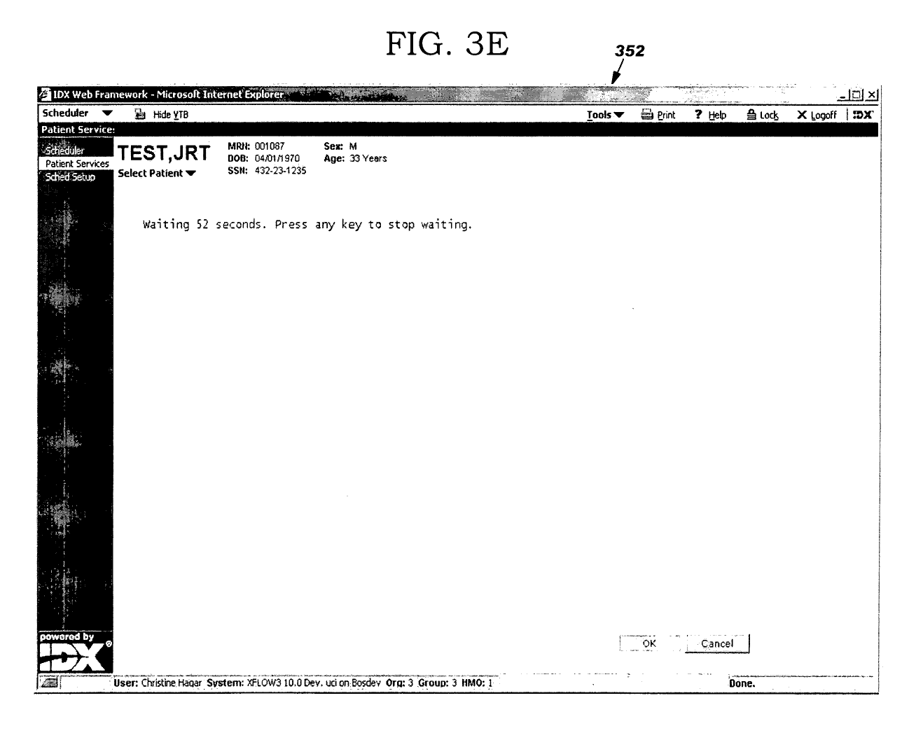

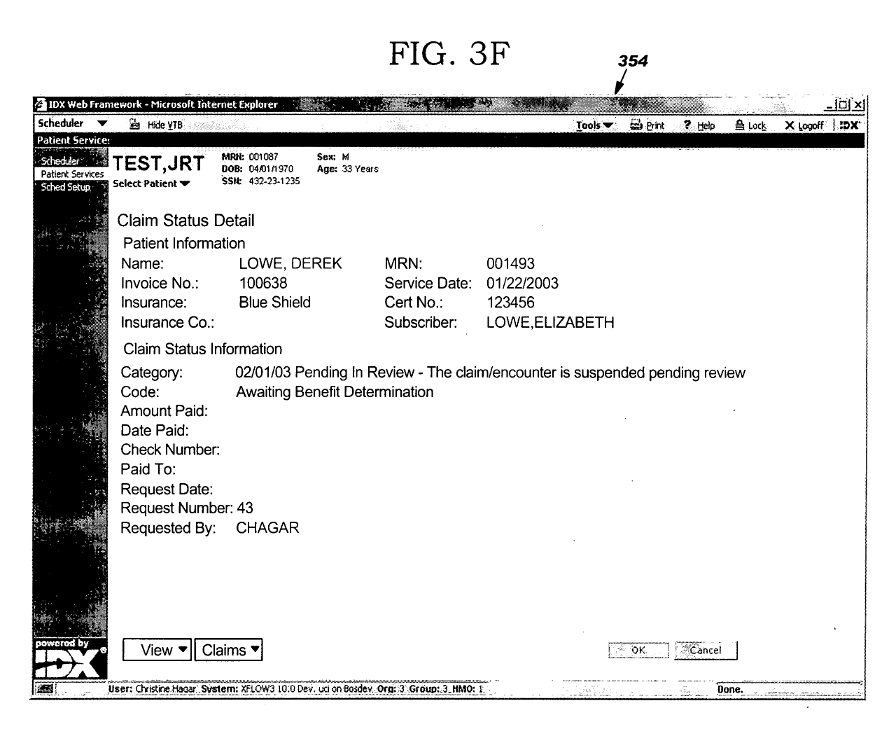

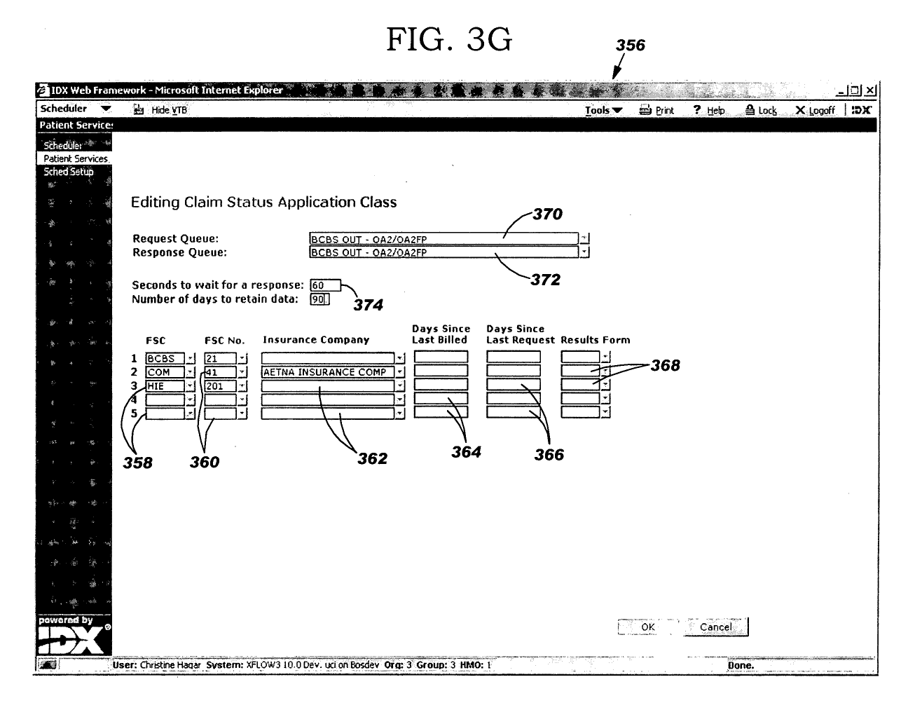

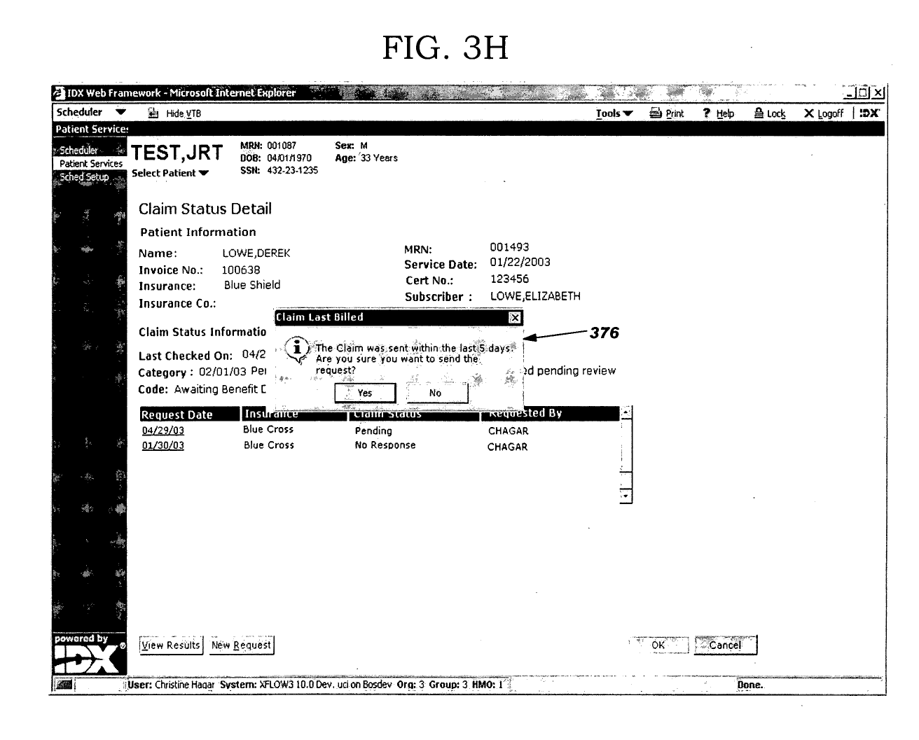

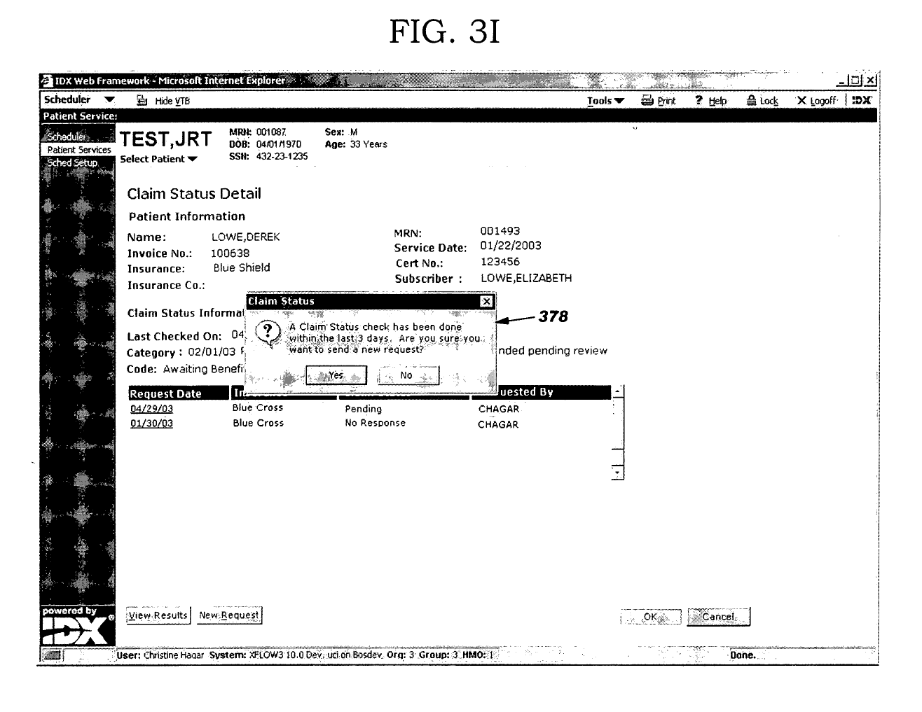

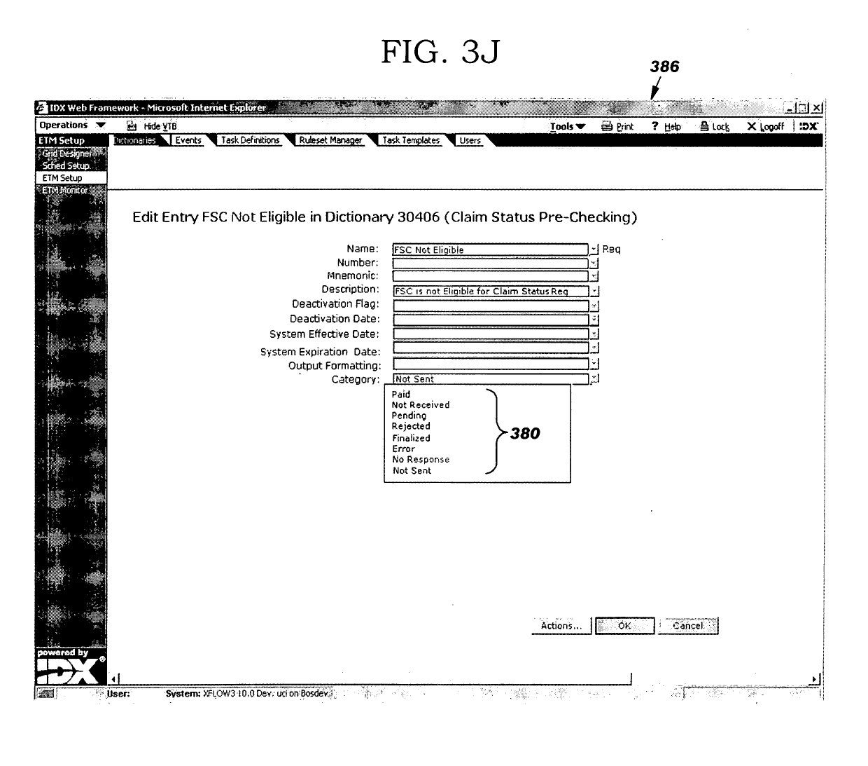

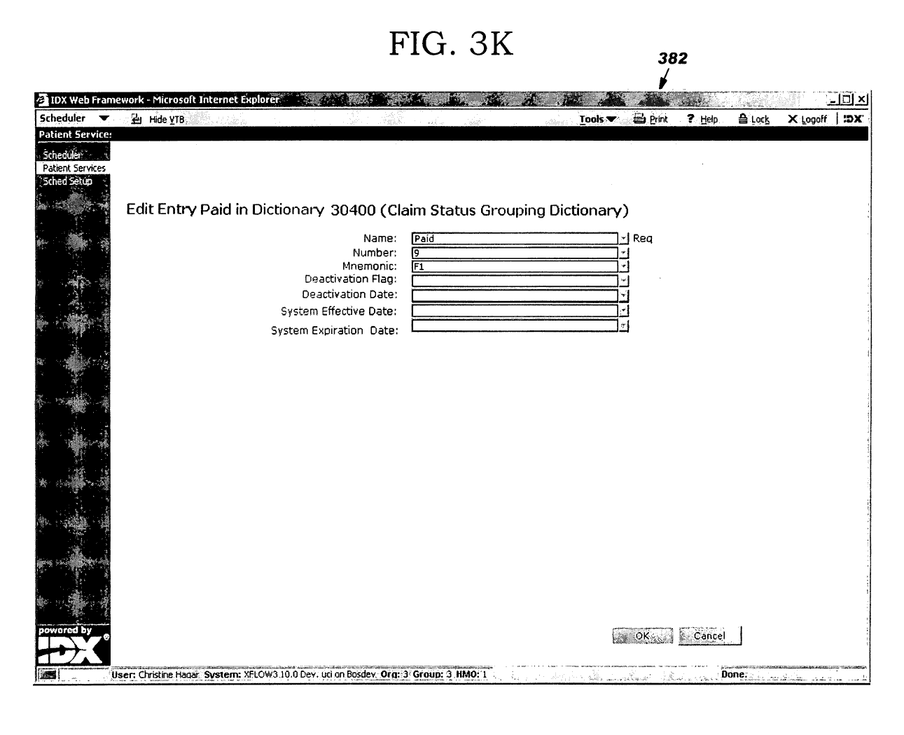

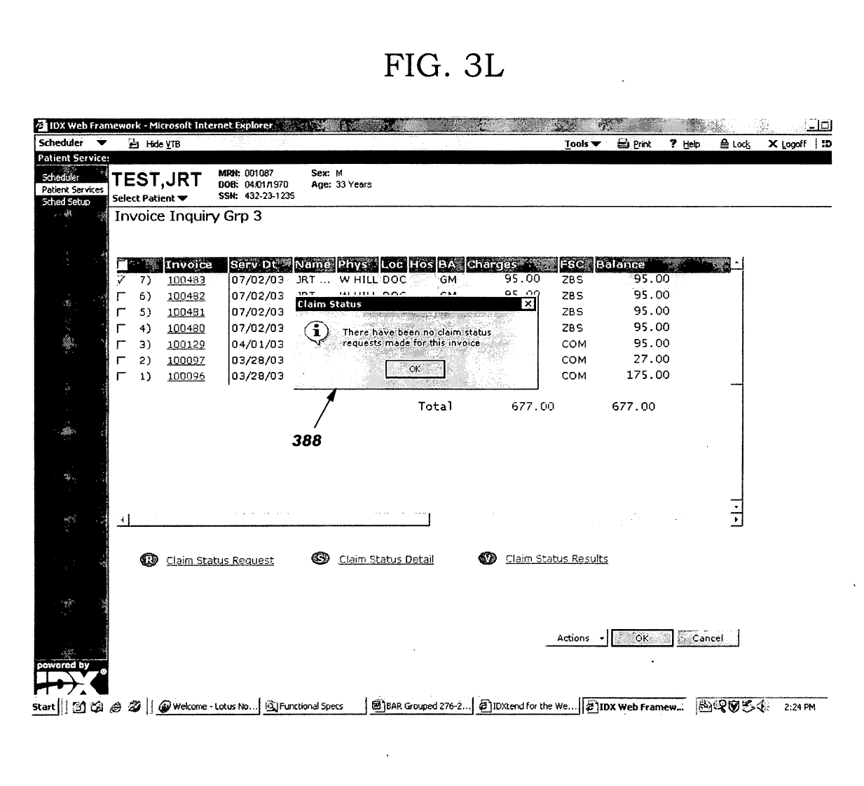

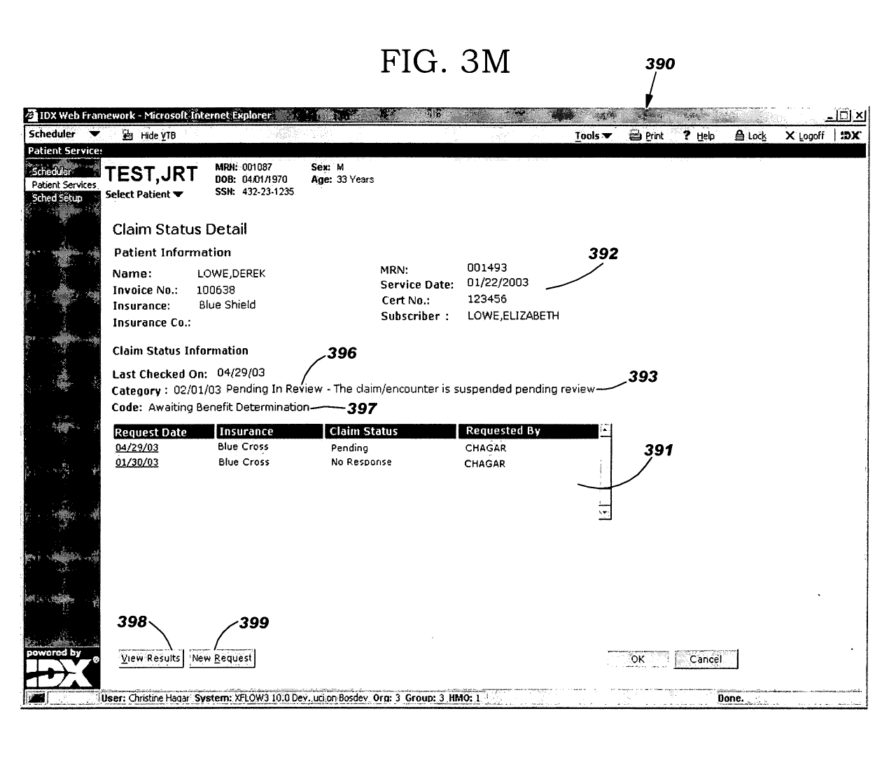

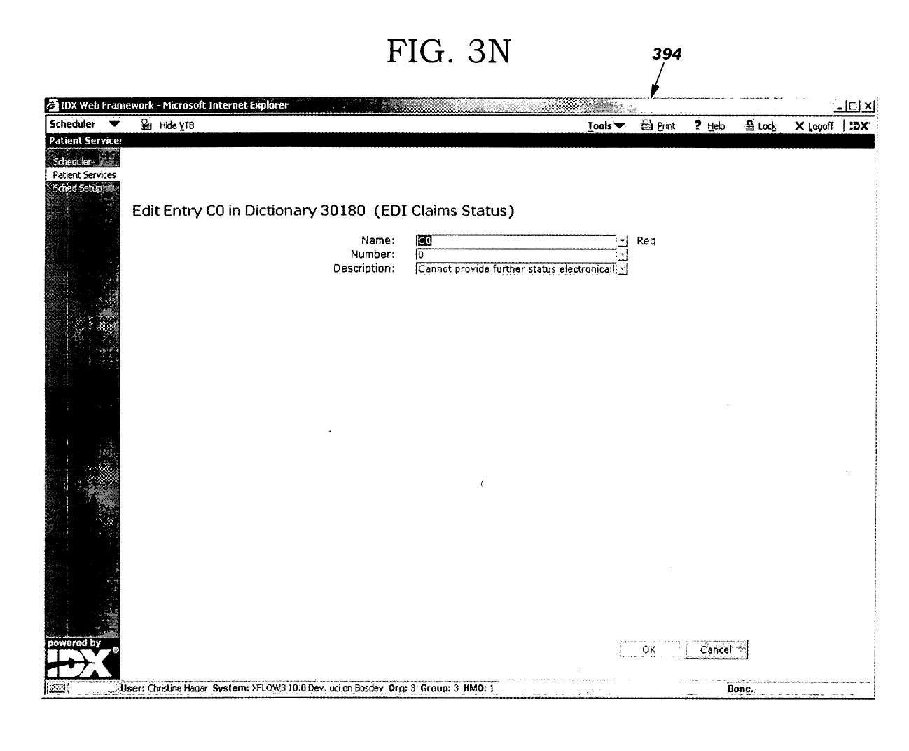

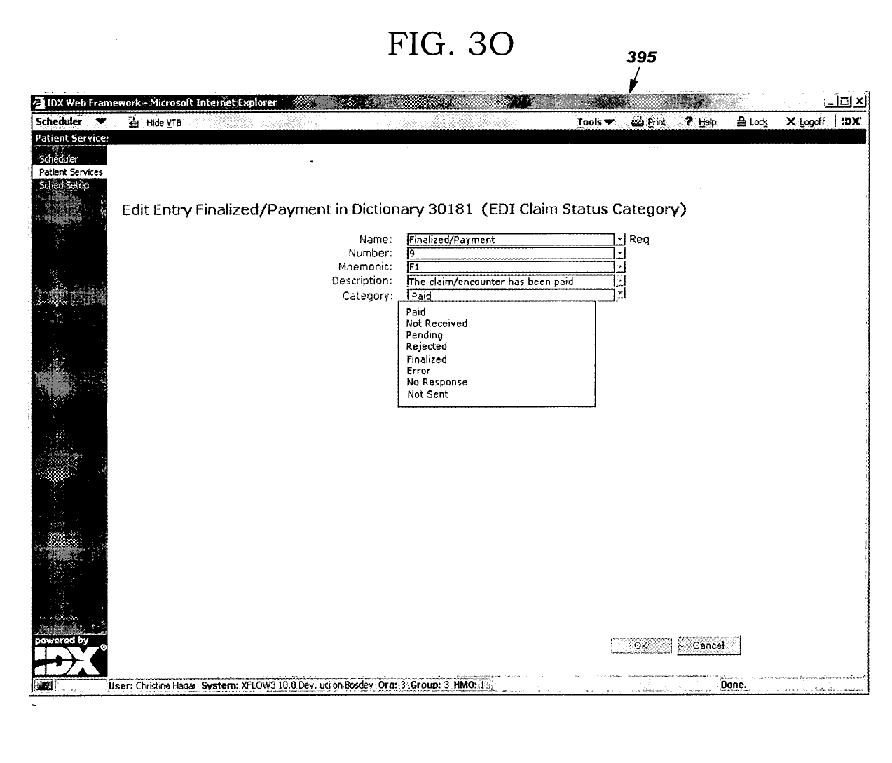

CST system 200 may include a health care software application 246, or simply “health care application,” having some level of patient accounting functionality, such as the ability to provide information to a user (not shown), e.g., provider billing/claims staff, provider claims follow-up staff and the like, relating to patient invoices. Health care application 246 may, of course, include many other functions, such as functions relating to patient registration, financials, appointments, chart tracking, referrals and visits, among others. FIG. 3A is a screenshot of a “homescreen” 300 of a user interface (UI) 250 (FIG. 2), e.g., a graphical UI (GUI) or a web user interface, that health care application 246 may display to a user via a user workstation 254. It is noted that in this example, health care application 246 is a browser based application and, consequently, UI 250 is shown as being a web user interface. However, those skilled in the art will understand that health care application 246 may be implemented in other ways, e.g., such as within an integrated software system wherein a GUI may be used. As illustrated by the various selectors, e.g., hyperlinks 304, provided on homescreen 300, the particular embodiment of health care application 246 illustrated includes an assortment of functions, many not relating directly to claims and claim statuses. These functions will be self-evident to those skilled in the art by merely reading the text of hyperlinks 304.

With continuing reference to FIG. 2, and also to FIG. 3A, health care application 246 may be based on any suitable legacy health care application modified to incorporate the automated CST functions described in general above. Examples of such legacy health care applications include the billing and accounts receivable (BAR), hospital patient administration (HPA), paperless collections system (PCS) and enterprise task manager (ETM) applications available as part of FLOWCAST™ software licensed by IDX Systems, Burlington, Vermont, among many others available from IDX Systems and others. For example, in one embodiment of CST system 200, the CST functions may be provided in a relatively stand-alone CST software application 258, or “module,” that can be interfaced with a legacy health care application 246 with relatively minor changes to the legacy application. That said, it is noted that the term “module” and similar terms as used herein and the appended claim denotes functionality, not necessarily any particular software architecture. When implemented in a legacy application scenario, CST module 258 may interface with health care application 246 by adding new links within various screens of UI 250 that essentially transfer processing from the health care application to the CST module when the user desires to implement one or more of the CST functions. Those skilled in the art will readily understand how to implement the present invention in virtually any sort of software architecture.

FIGS. 3A-3D illustrate a series of screens 300, 308, 312, 316 that illustrate one path within UI 250 that the user may take to access various functions of CST module 258. The screen of FIG. 3A, i.e., homescreen 300, is a “Patient Services” screen that may allow the user to perform any of a number of functions relative to a certain patient. In this example, the user would begin by inputting into a patient name field 320 the name of a patient for which the user may wish to implement one or more of the CST functions of CST module 258. In this example, the CST functions are accessed via “Invoice List” hyperlink 324. When the user selects “Invoice List” hyperlink 324, Ul 250 may present the user with screen 308 shown in FIG. 3B. This screen 308 may include, among other things, a patient data frame 328, an invoice list frame 330 and a desired action frame 332. Invoice list frame 330 may contain a list of invoices 334 corresponding to the patient selected on homescreen 300 of FIG. 3A and for which some of the general patient information appears in patient data frame 328. Desired action frame 332 may contain a list, or array or other arrangement of selectors (hyperlinks 336, buttons or other selectors) corresponding to various functions that may be performed from screen. In the present example, one of hyperlinks 336 that the user may select is an “EDI” hyperlink 338, which may provide the user with access to various functions that utilize EDI interface 240 so as to enable communication between CST system 200 and remote applications, e.g., adjudication applications 236 of payers 216. When the user selects “EDI” hyperlink 338, Ul 250 may present screen 312 of FIG. 3C to the user.

Screen 312 of FIG. 3C may be essentially the same as screen 308 of FIG. 3B, except for the available selections presented in desired actions frame 332. On screen 312, UI 250 may present the user with, among others, a selector directed to providing the user with access to functions provided by CST module 258, e.g., a “Claims Status” hyperlink 340. Upon the user selecting “Claims Status” hyperlink 340, UI 250 may present to the user screen 316 of FIG. 3D that is largely the same as screens 308, 312 of FIGS. 3B and 3C, except for the available selection appearing in desired actions frame 332. It is from screen 316 in the present example that the user may elect to pass processing over to CST module 258 by selecting any one of the three available selections illustrated, namely, “Claims Status Request” hyperlink 342, “Claim Status Detail” hyperlink 344 and “Claim Status Results” hyperlink 346.

Those skilled in the art will readily appreciate a number of matters that flow from the immediately preceding description of how various CST functions of CST module 258 may be accessed. For example, those skilled in the art will readily understand that although this example is presented relative to accessing CST functions via “Invoice List” hyperlink 324 (FIG. 3A), “EDI” hyperlink 338 (FIG. 3B), “Claim Status” hyperlink 340 (FIG. 3C) and any of “Claims Status Request,” “Claim Status Detail” and “Claim Status Results” hyperlinks 342, 344, 346 (FIG. 3D), a user may access these and/or other CST functions via another series of hyperlinks, or other selectors, perhaps starting with “Current Stmt Balance” hyperlink 348 on homescreen 300 of FIG. 3A. This may then take the user through a different series of screens and/or choices of CST functions. Also, those skilled in the art will readily understand that, relative to “Invoice List” hyperlink 324 and corresponding functionality, functions of CST module 258 can be added to a legacy version of health care application 246 simply by adding appropriate selectors, e.g., “Claim Status” hyperlink 340 of FIG. 3C and “Claims Status Request,” “Claim Status Detail” and “Claim Status Results” hyperlinks 342, 344, 346 of FIG. 3D, to the appropriate existing screens of UI 250. For example, in the context of screens 300, 308, 312, 316 of FIGS. 3A-D, except for the new hyperlinks 340, 342, 344, 346, these screens may be identical to the same screens of a legacy version of health care application 246.

Referring to FIG. 3D, a user may initiate a process of assembling and sending one or more new claim status requests 228 by first selecting one or more of the invoices 334 displayed in invoice list frame 330, e.g., by checking the appropriate one(s) of the corresponding checkboxes 350, and then selecting “Claim Status Request” hyperlink 342. When the user selects “Claim Status Request” hyperlink 342, processing may be transferred to a request assembly sub-module 262 within CST module 258. (Again, it is noted that the terms “module” “sub-module” and the like are used herein and in the appended claims for convenience to denote various levels and types of functionality, and are not intended to limit the physical arrangement of the corresponding computer instructions in any way.) By the user selecting “Claim Status Request” hyperlink 342, request assembly sub-module 262 may generate a claim status request 228 for each invoice 334 in invoice list frame 330 that the user has selected. Generally, the generation of each claim status request 228 will be a function of the information that CST module 258 needs to send the request and that the corresponding payer 216 needs in order to determine the status of the corresponding claims, e.g., payer identification, patient name, service date, provider name, claim date and/or any other claim-identifying data. If claim status requests 228 use the 276 request standard discussed above, request assembly sub-module 262 will generate each request in the format defined by the ASC X12N subcommittee. The data needed to populate each claim status request 228 may be stored in one or more databases, such as database 266. Those skilled in the art will readily understand how to operatively configure request assembly sub-module 262 so as to assemble each claim status request 228, such that that detailed explanation is not necessary for those skilled in the art to understand and practice the various aspects of the present invention to their fullest scope as defined by the appended claims.

Depending upon the speed of processing claim status requests 228 by both CST module 258 and the adjudication 236 of each payer 216 application, if the user selects more than one invoice 334, upon selection of Claim Status Request hyperlink 342, UI 270 of CST module 258 may present a message (not shown) to the user, e.g., via a popup window, indicating that the CST module is processing the request and that the user should check back later to see the results. CST module may then proceed with processing the multiple requests 228, e.g., as described below. If the user selects only one invoice 334 and then selects the Claim Status Request hyperlink 342, UI 270 may present a timer screen, such as countdown timer screen 352 of FIG. 3E, to the user that displays a timer while the corresponding claim status request 228 is being processed.

Typically, the countdown would start from a predetermined time that is equal to or greater than some expected value of total processing time, i.e., generally, the sum of the time CST module 258 takes to process and send claim status request 228, the time adjudication application 236 takes to process the request and send a claim status response 232 and the time the CST module takes to process the response and display the results. If the countdown reaches zero and CST module 258 has not yet received and processed a claim status response 232, UI 270 may remove timer screen 352 from user workstation 254 and the CST module may return processing to health care application 246, e.g., making screen 316 of FIG. 3D active again. If, on the other hand, CST module 258 receives and processes a proper claim status response 232, UI 270 may display the results contained in the response, e.g., on a claim status results screen 354 as shown in FIG. 3F. Results screen 354 may contain any patient account information and information contained in the corresponding claim status response 232 that a user, or more likely, the entity that licensed CST module 258, desires. If the user does not wish to remain in this timer mode, they may press any keyboard key, or perform any other action instructed, to exit this mode. Upon the user actively terminating the countdown, UI 270 may remove screen 352 of FIG. 3E from user workstation 254 and CST module 258 may return processing to health care application 246, e.g., by making screen 316 of FIG. 3D active again.

Once request assembly sub-module 262 has assembled a claim status request 228, the status request may be passed to pre-checking sub-module 272, which may be operatively configured to perform several checks prior to CST module 258 sending the request to the appropriate payer 216. Following are several examples of checks that pre-checking sub-module 272 may perform. Of course, pre-checking sub-module 272 may be programmed to perform other checks, e.g., checking that all fields of each claim status request 228 are properly populated in accordance with the requirements of the payer 216 at issue. One check that pre-checking sub-module 272 may perform is a payer-eligibility check to verify that the appropriate payer 216 is in fact set up to handle electronic claim status transactions. Some payers 216 may simply not be set up to receive, process and respond to electronic claim status requests 228. However, the user of health care application 246 and CST module 258 may not know this. In this event, if a user attempts to send an electronic claim status request 228 to a non-eligible payer 216, pre-checking sub-module 272 will “catch” the request and notify the user that the request cannot be sent because that payer is not equipped to handle such electronic claim status requests.

This payer eligibility check may be implemented in any of a number of ways, including via the provision of a trading partners module 274 (or sub-module) in either health care application 246 or CST module 258. Trading partners (sub-)module 274 may be used to set up various parameters so that CST system 200 may send and receive data, e.g., health care claims (not shown), claim status requests 228 and claim status responses 232, among others, to and from various trading partners, e.g., payers 216. These parameters include, among others, parameters needed to enable CST system 200 to electronically communicate with the various trading partners, since at least some of the parameters will vary from trading partner to trading partner. Examples of these parameters include Internet address, communications protocol(s), handshake information and input and output queues (not shown) of CST system 200, among others. In connection with trading partners (sub-)module 274, either UI 250 or UI 270 may, as shown in FIG. 3G, display a screen 356 for inputting the appropriate parameters and other information for each trading partner. The parameters and other data relating to the trading partners may be stored in a trading partners file 276 stored, e.g., in database 266.

Examples of information that may be used to identify trading partners that are payers 216 capable of handling electronic claim status requests 228 and responses 232 include a payer type (“FSC” fields 358), unique payer identification number (“FSC No.” fields 360) and payer name (“Insurance Company” fields 362 —used only if the payer type is denoted “COM,” i.e., commercial payer). Examples of parameters that may be provided for each payer 216 for use in CST system 200 include: the number of days since last billed (“Days Since Last Billed” field 364); the number of days since the last claim status request 228 was sent (“Days Since Last Request” field 366); the results form (not shown) that CST module 358 should use to display data returned in a status response 232 (“Results Form” field 368); an identification of the queue for sending claim status requests (“Request Queue” field 370); an identification of the queue for receiving claims status responses (“Response Queue” field 372) and the number of seconds to wait for a response (“Seconds to wait for a response” field 374), among others.

If a user would like to view the results returned from a particular payer 216 in a certain format, the user may identify in “Results Form” field 368 a formatting file (not shown) that CST system 200 will use for that payer. CST system 200 may be configured such that if “Results Form” field 368 is empty, CST module 258 will, by default, use a standard format preprogrammed into the CST module. When one of payers 216 is highlighted on screen 356, e.g., by the user selecting a corresponding one of “FSC,” “FSC No.” or “Insurance Company” fields 358, 360, 362, user may enter into “Request Queue” field 370 and “Response Queue” field 372 the appropriate request and response queue identifiers corresponding to queues CST system 200 uses to send and receive data to and from that payer via EDI interface 240. If the queue identifiers have already been entered, selecting one of payers 216 will display the corresponding queue identifiers in the respective “Request Queue” and “Response Queue” fields 270, 272. Each of the other parameters is described below in connection with pre-checking sub-module 272.

As mentioned above, one of the checks that pre-checking sub-module 272 may perform after a claim status request 228 has been assembled, but before it has been sent, is to determine whether or not the payer 216 corresponding to the request can in fact handle such electronic transactions. Pre-checking sub-module 272 may perform this function, e.g., simply by determining whether or not the payer 216 is identified in transaction partners file 276. If the payer 216 is not identified in transaction partners file 276, UI 270 may display to the user, e.g., in a popup window (not shown), that the payer does not presently handle electronic transactions. On the other hand, if the payer 216 is identified in transaction partners file 276, pre-checking sub-module 272 may continue with other checks of each claim status request 228 prior to CST modules 258 sending the request. Another check that pre-checking sub-module 272 may perform is to determine if health care application 246 has sent a claim corresponding to the particular claim status request 228 at issue. If not, the respective payer 216 simply cannot provide a substantive response and there would not be any benefit to sending the request. To the contrary, the sending of a claim status request 228 for an un-submitted claim would only waste resources of the payer 216 and communications link 220.

As discussed above and shown in FIG. 3G, screen 356 may include “Days Since Last Billed” field 364 that allows a user to enter for each trading partner, i.e., payer 216 in this case, the number of days corresponding to the time from the date a claim is originally sent until the date the payer would likely have status information available for electronic retrieval. This time is generally equal to the time that it takes that payer to process a new claim to a point where it can also respond to an electronic claim status request 228. Consequently, if a claim was sent too recently, it would be a waste of time and resources to send a claim status request 228 for that claim. In addition, sending a claim status request 228 before the payer 216 has had an opportunity to process the claim may result in the incurrence of an unnecessary charge, since some payers 216 charge transaction fees for handling such requests. Pre-checking sub-module 272 may use the time period in “Days Since Last Billed” field 364 to determine whether or not UI 270 should display to the user a message, e.g., in a popup window 376 (FIG. 3H), alerting the user that the claim selected for the status check was sent within that time period and asking the user if they want to continue with sending claim status request 228. This is useful in that, if the claim was sent within a number of days fewer than the number of days it typically takes for payer 216 to be able to respond to a claim status request 228, then it would be likely that the payer will not be able to provide the user with any status information, other than, e.g., that the status is not available or the like.

Pre-checking sub-module 272 may perform similar actions for similar reasons for the time period present in “Days Since Last Request” field 366 for a particular payer 216. In this case, however, instead of this time period corresponding to the time it typically takes the corresponding payer 216 to be able to provide claim status information for a newly submitted claim, this time represents the fact if a claim status check was recently made relative to a particular claim, it is not likely that the payer has changed any of the status information for that claim since the last status check. The time period input into “Day Since Last Request” field 366 may be the typical time it takes a payer 216 to update status information and make the updated information available electronically after someone sends additional or corrected information regarding the claim to the payer. Upon pre-checking sub-module 272 performing a check between the date of claims status request 228 (current date) and the date that a similar request was last made for the claim at issue using CST system 200, UI 270 may display a message, e.g., via a popup window 378 (FIG. 3I), to the user alerting the user that a status check was made within the time period specified in “Days Since Last Request” field 366 and asking the user if they want to continue with sending the claim status request 228. Those skilled in the art will readily appreciate that the pre-checks discussed above are illustrative and that pre-checking module 272 may be operatively configured for performing virtually any pre-check desired.

If a claim status request 228 does not pass a pre-check, e.g., the payer 216 is not set up to perform electronic request/response transactions, or the user decides based on the pre-check that the request is not warranted at this time, e.g., due to the corresponding claim having been submitted so recently that the payer is not likely to provide a meaningful response, then pre-checking sub-module 272 may assign to the request a CST category, e.g., “Not Sent,” that identifies the request as being unsent. In this connection and referring to FIG. 3J, CST module 258 may be operatively configured to include a number of CST categories 380 for categorizing claim status requests 228 and claim status responses 232. In addition to “Not Sent”, other CST categories 380 may include “Paid,” “Not Received,” “Pending,” “Rejected,” “Finalized,” “Error” and “No Response,” among others. Information regarding CST categories 380 may be stored in a claim status grouping dictionary 278 within database 266. FIG. 3K illustrates a screen 382 that UI 270 may display to the user that allows the user to set up and/or maintain claim status grouping dictionary 278 when the category identifiers used during processing of claim status requests 228 and/or responses 232 are numeric. In this case, claim status grouping dictionary 278 may contain at least a listing of all of CST categories 380 (the category “Paid” is illustrated in FIG. K) and the corresponding category identifiers (in this example, the numeral “9” in “Number” field identifies the “Paid” category).

When a claim status request 228 is not going to be sent, pre-checking sub-module 272 may also assign a pre-defined error code (not shown) to the request indicating which of the pre-checks the request did not pass. Correspondingly and referring again to FIGS. 2 and 3J, CST system 200 may also include a pre-checking dictionary 279 in database 266 that provides a description for each of the error codes and UI 270 may provide a screen 386 that allows a user to create and maintain the dictionary. For example, for an “FSC Not Eligible” error, the accompanying description may be “FSC is not Eligible for Claim Status Request.” For a “Claim Last Sent” error (not shown), the accompanying description may be “The Claim was sent within the last “_BILLCHK_” days,” wherein the_BILLCHK_variable indicates the value provided in Days Since Last Billed field 364 of screen 356 (FIG. 3G). The names and descriptions of other pre-checking errors will be self-evident to those skilled in the art. CST system 200 may be operatively configured to utilize information regarding the pre-check error at issue to provide the user with details of why a particular claim status request 228 was not sent, e.g., in a claim status detail screen, described in more detail below.

If a claim status request 228 passes the pre-checking phase, pre-checking sub-module 272 may pass processing to a communications sub-module 280, which may be operatively configured for sending the status request to the appropriate one of payers 216. For example, communications sub-module 280 may contain the appropriate instructions for placing the claim status request 228 in the appropriate queue, e.g., the request queue identified in “Request Queue” field 370 of transactions partner screen 356 of FIG. 3G for the corresponding payer 216. Communications sub-module 280 may also be operatively configured to assign a claim status request 228 to one of CST categories 380 (FIG. 3J), e.g., “Not Received” or “No Response,” among others, when, respectively, the corresponding payer 216 has not received a sent request or the communications sub-module has not received a corresponding claim status response after a certain amount of time has passed. Reasons for a payer 216 not receiving a claim status request 228 include problems with the payer's EDI interface 242 or problems in communications link 220, among others. Reasons for a claim status response 228 not being received by communications sub-module 280 include problems with a payer's adjudication application 236, among others. Some effects, if any, on subsequent processing of a claim status request 228 after communications sub-module 280 has assigned it to one of CST categories 380 (FIG. 3J) are discussed below in more detail. However, in general, in order for CST module 258 to determine how to handle a categorized claim status request 228, communications sub-module 280 may essentially pass the request to a routing sub-module 282 that may determine where to route the request and may send the request, or more generally, information regarding the request, to the appropriate location within or, optionally, outside, CST system 200.

Communications sub-module 280 may also be operatively configured to receive claim status responses 232 made by payers 216 in response to claim status requests 228 successfully sent by CST module 258 and received and successfully processed by the corresponding adjudication applications 236. In addition, as discussed below in more detail, communications sub-module 280 may be operatively configured to assign each claim status response 232/transaction set 224 to an appropriate one of CST categories 380 (FIG. 3J). Generally, communications sub-module 280 may assign claim status responses 232/transaction sets 224 to CST categories 380 based on information provided by payers 216 in the respective responses. Once communications sub-module 280 has assigned one of CST categories 380, it may essentially pass the response 228/transaction set 224 to routing sub-module 282, which may determine where to “route” the response/transaction set and send the response/transaction, or more generally, information regarding the response/transaction set, to the appropriate location within or, optionally, outside, CST system 200.

Referring again to FIG. 3D, depending upon a user's needs, the user may in addition, or alternatively, to selecting “Claim Status Request” hyperlink 342 select “Claim Status Detail” hyperlink 344 or “Claim Status Results” hyperlink 346. Selecting one or more of invoices 334 displayed in invoice list frame 330 and then selecting “Claim Status Detail” hyperlink 344 may cause a claim status display sub-module 284 to determine whether or not a claim status request 228 has been sent for each invoice 334 selected. If a claim status request 228 has not yet been sent for a particular invoice 334 (FIG. 3D), claim status display sub-module 284 and UI 270 may display a notification, e.g., via a popup window 388 (FIG. 3L), to the user that no requests have been sent for the corresponding invoice. For each invoice 334 for which at least one claim status request 228 has previously been sent, claim status display sub-module 284 and UI 270 may display a claim status detail screen, such as screen 390 shown in FIG. 3M, that includes a history frame 391 that shows a listing of information relating to all of the claim status requests 228 that have been made relative to the claim at issue. The information listed for each claim status request 228 in history frame 391 may be any information regarding the request(s) and/or response(s) 232, e.g., the request date, payer name, claim status and name of the user making the request. The data for claim status may be the appropriate CST categories 380 identifier from pre-checking dictionary 279 discussed above in connection with FIG. 3J.

Screen 390 of FIG. 3M may also include a “Patient Information” region 392 containing various information regarding the patient and a “Claim Status Information” region 393 containing a summary of information about the one or more claim status requests listed in history frame 391. “Claim Status Information” region 393 may contain virtually any information desired regarding the one or more claim status requests 228. In the present example, “Claim Status Information” region 393 contains the date the most recent claim status request 228 for the claim (corresponding to a particular invoice 334 (FIG. 3D)) at issue was made, a description of a response category of the claim status response and a description of a response code of the response. The use of a response category and a response code in implementing the present invention is largely due to 277 responses containing such category and code to convey claim status information to a user. Generally these 277 categories and codes developed by X12N are rather cryptic and are of little value when presented directly to a user. Hence, it is descriptions of the category and code provided by system 200 of the present invention that are useful to the user.

In general, and when implemented, the response categories and codes may be identified by any suitable identifiers, such as various characters or character strings, that distinguish each category or code from the others. For example, each response category may be identified by a single character or a two-character set. In this connection, FIG. 3N shows a screen 394 that UI 270 may present to a user that provides an interface to a response category dictionary 290 (FIG. 2) that contains various information regarding each response category, such as the corresponding category identifier (“0” in FIG. 3N), a name of the category (e.g., “C0”) and a description of the response category (e.g., “Cannot provide further status electronically”). Similarly, FIG. 30 illustrates a screen 395 that UI 270 may present to a user that provides an interface to a response code dictionary 292 that contains various information regarding each response code (which is “9” in the present example). In addition to a name (e.g., “Finalized/ Payment”) and a description (e.g., “The claim/encounter has been paid”), the information contained in response code dictionary 292 for each response code may include one of CST categories 380 (FIG. 3J) (e.g., “Paid”) into which the particular response category/code pair at issue should fall. As mentioned above, CST system 200 may be configured to process claim status responses 232 (and requests 228) based upon which one of CST categories 380 the response (or request 228) at issue is assigned.

Returning to FIG. 3M, the descriptions of response categories and codes are used in Claim Status Information region to populate the “Category:” and “Code:” fields 396, 397 therein. Screen 390 may also include a “View Results” link, e.g., button 398, that allows the user to see more detail regarding the particular claim status request 228 listed in claim status history frame 391 and/or more detailed patient information. Such a detailed view may contain as much or as little additional information desired. For example, regarding the additional information concerning a claim status request 228, a view results sub-module 294 associated with “View Results” button 398 could be operatively configured to display all of the information in the 276/277 transaction set corresponding to that request. In addition to providing features directed to past claim status requests 228, screen 390 may optionally include a link, e.g., “New Request” button 399 that links to request assembly sub-module 262 that allows the user to initiate a new claim status request process. Once the user has selected “New Request” button, CST module 258 may assemble and pre-check the new claim status request 228 in a manner similar to the manner described above in connection with request assembly sub-module 262 and pre-checking sub-module 272.

Referring again to FIG. 3D, if the user has selected one or more of invoices 334 in invoice list frame 330 and the user selects “Claim Status Results” hyperlink 346, claim status display sub-module 284 and UI 270 may display to the user screen 354 of FIG. 3F showing claim status results for only the most recent claim status request 228 made for the corresponding invoice(s). If the user had selected multiple invoices, CST module 258 may display the several results screens 354 in seriatim, with the user moving from one screen to another in any of a variety of ways, including closing a screen or making another screen active, among others. If a claims status request 228 has never been initiated for a particular invoice 334, claim status display sub-module 284 may display a message to the user, e.g., in a popup window (not shown), indicating that a claim status request has not yet been made and ask the user if it is desired to send a request now. If the user desires to initiate sending of a new claim status request 228, the user may select within the popup window a link to claim status assembly sub-module 262, at which point processing will be passed from claim status display sub-module 284 to the claim status assembly sub-module. On the other hand, if the user does not wish to make a claim status request at this time, the user may simply cancel out of the popup window and return to screen 316 of FIG. 3D.

As mentioned above in connection with FIG. 1, an important feature of a CST system of the present invention, such as CST system 200, is that it may be operatively configured to provide “intelligent routing” of claim status requests 228 and responses 232 depending upon what actions must be taken once a request or response has been categorized, e.g., using CST categories 380 (see FIG. 3J). This has been seen already relative to claim status requests 228 assigned to the category “Not Sent” by pre-checking sub-module 272 and status requests assigned to categories “Not Received” and “No Response” by communications sub-module 280. In those examples, claim status requests 228 assigned to the “Not Sent” category may be posted to a follow-up list, e.g., a worklist 295 of health care application 246, from which one or more users, e.g. follow-up staff, may work to follow up on the unsent requests 228 as appropriate or sent to the appropriate request queue for resending to the payer 216.

Relative to intelligent routing of claim status responses 232, CST system 200, e.g., via routing sub-module 282, may be operatively configured to “route” claim status transaction information to any feature that health care application 246 may include to facilitate processing transaction information. For example, health care application 246 may include a variety of follow-up lists 296 for one or more follow-up workers to act upon. Examples of such follow-up lists 296 include one or more lists for correcting request information, e.g., patient information, that may have prevented a payer from providing a complete claim status response. Claim transaction sets 224 needing this sort of follow-up may be transaction sets for which the CST category is “Error” (see FIG. 3J). Another one of CST categories 380 that may need follow-up is “No Response,” which may be used to indicate that CST system has not received a claim status response 232 after a certain period of time has passed since the CST system sent the corresponding status request.

Depending on their CST categories 380, other claim transaction sets 224 may require no human follow up, but may trigger other events. For example, if a payer 216 indicates in a claim status response 228 via a response category/code pair that it rejects a claim, communications sub-module 280 may assign the corresponding transaction set 224 to the “Rejected” category. In this event, routing sub-module 282 may route the transaction set to a write-off sub-module 297 of health care claim application 246 that may process the corresponding rejected claim in substantially the same manner rejected claims are presently processed. However, in the case of the present invention, transfer to a write-off phase is handled automatically with intelligent routing of transaction sets 224 based on a payer's electronic response 232. Another one of CST categories 380 (FIG. 3J) that may trigger an event is the “Not Received” category. If CST module 258 sends a claim status request 228 but the payer 216 does not receive the request, e.g., due to connection problems, communications sub-module 280 may assign the request to the “Not Received” category. When routing sub-module 282 detects the CST category identifier (not shown) attached to the un-received claim status request 228, it may route the request to a queue for resending, e.g., the request queue designated in “Request Queue” field 370 of screen 356 in FIG. 3G. Other types of intelligent routing may be provided for other CST categories 380 (FIG. 3J) as needed to suit a particular application.

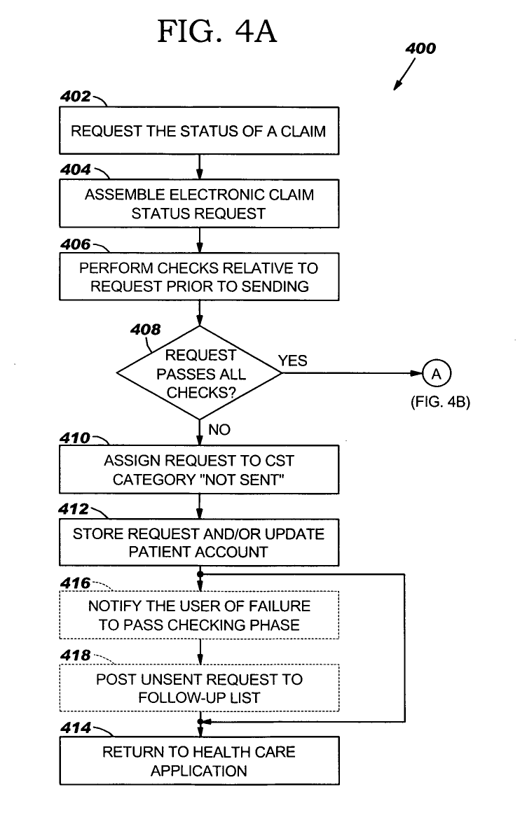

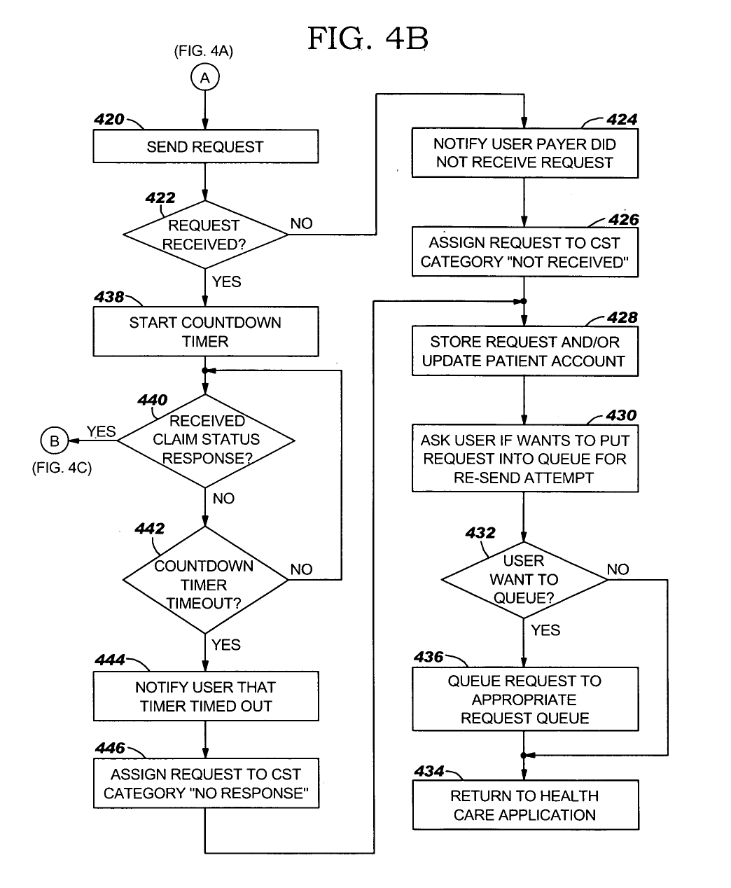

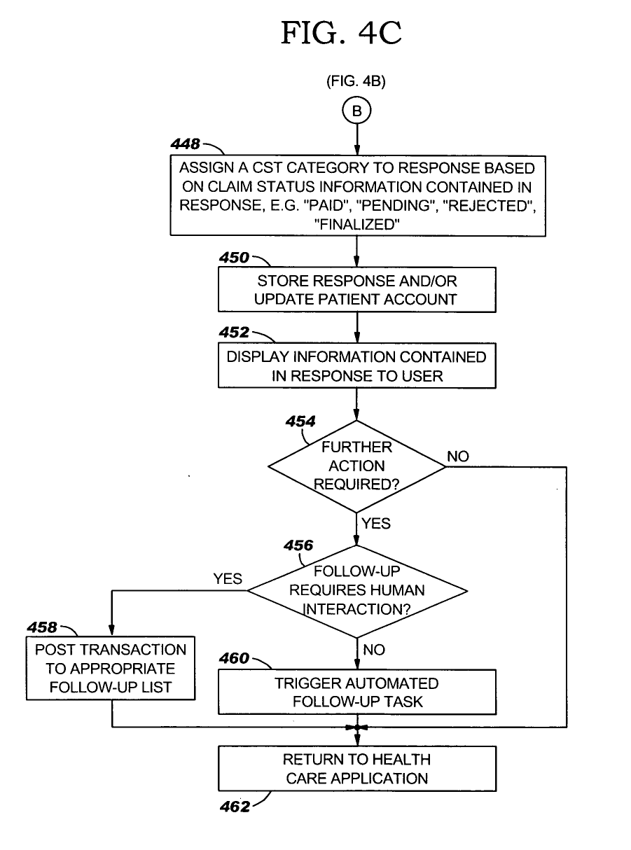

Referring now to FIGS. 4A-4C, and also to FIG. 2 and other figures as occasionally referenced below, FIGS. 4A-4C illustrate an automated CST method 400 of the present invention that may be implemented in conjunction with, e.g., CST system 200 of FIG. 2. CST method 400 may begin at step 402, with a user initiating the process of sending a claim status request 228 to a payer 216 in order to determine the status of the corresponding claim (not shown). In the context of CST system 200, the user may initiate this process by selecting the “Claim Status Request” hyperlink on screen 316 of FIG. 3D. Once the user has initiated a claim status request 228, at step 404 the request may be assembled automatically, e.g., by request assembly sub-module 262. Assembly of the claim status request 228 will generally be dependent upon the information needed in the request for the corresponding one of payers 216 to be able to respond with a proper claim status response 232. Typically, assembly of a claim status request 228 includes populating the request with various information from patient account data stored in database 266.

Once claim status request 228 has been assembled, at step 406 the request may be checked, e.g., by pre-checking sub-module 272, prior to an attempt being made to send the request. This pre-checking can be useful to reduce the likelihood that an avoidable error or redundancy will occur in the sending of claim status request 228 and/or the processing of the request by the corresponding payer 216. As discussed above, these pre-checks may include, among others, ensuring that payer 216 is eligible to receive automated claim status requests 228 and determining whether the user wants to send the request even though a similar request for the claim at issue had been sent very recently, among others. At step 408, it is determined, e.g., by pre-checking sub-module 272, whether claim status request 228 has passed all of the pre-checks. If not, at steps 410 and 412 claim status request 228 may be assigned to the “Not Sent” category of CST categories 380 (FIG. 3J) and then the request may be stored and/or patient account updated to reflect that the request has not been sent. As discussed above, CST categories 380 can be used to control the processing of claim status requests 228 and responses 232. After the patient account has been updated, in the context of CST system 200, at step 414 processing may revert from CST module 258 back to health care application 246. Optionally, prior to processing reverting to health care application, at step 416 CST module 258 may notify the user that claim status request 228 failed to pass the pre-checking phase and then, at step 418, post the unsent request to a follow-up list, e.g., one of follow-up lists 296, for follow up by follow-up staff to, e.g., correct missing or incorrect information or manually process the request, depending upon the situation.

If at step 408 claim status request 228 had passed all of the pre-checks, at step 420 the request may be sent, e.g., by communications module 280. At step 422, it may be determined whether or not the intended payer 216 appears to have received claim status request 228. The presence of step 422 in CST method 400 will generally depend upon the communications link 220 between health care provider server 208 and payer server 212 at issue and the communications protocol used to send claim status request 228. For example, if the communications protocol requires some sort of handshake, authentication or other type of protocol that requires some sort of interaction between provider server 208 and payer server 212 before claim status request 228 is sent, then failure of such interaction indicates that the payer server has, or cannot, receive the request. Of course, those skilled in the art will appreciate that there are other reasons that the payer 216 at issue has not received a claim status request.

In any event, if payer 216 has not received claim status request 228, at steps 424 and 426 the user may be notified that the payer did not receive the request and the request may be assigned to the “Not Received” category of CST categories 380 (FIG. 3J). Then, claim status request may be stored, e.g., in database 266, and/or the patient account may be updated at step 428 to reflect that payer 216 has not received claim status request 228 for which a sending has been attempted. Since payer 216 may not have received claim status request 228 for a reason such as the corresponding payer server 212 being temporarily off-line, it may be useful to ask the user if the request should be put into the appropriate request queue for resending at a later time. This is shown at step 430. At step 432, if the user does not wish to queue claim status request 228 for resending, in the context of CST system 200 at step 434, processing may return to health care application 246. On the other hand, if the user wishes that claim status request 228 be resent, at step 436 the request may be sent to the appropriate request queue, e.g., the request queue identified in request queue field 370 on screen 356 of FIG. 3G.

If at step 422 payer 216 had received claim status request 228, then at step 438 it may be desirable to start a countdown timer that waits a reasonable amount of time for payer 216 to process the request and provide a corresponding claim status response 232 in real time. As mentioned above, the reasonable amount of time may correspond to some measure of time beyond which if a claim status response 232 has not been received, it is likely that a response will not be received in a timely manner. Accordingly, at steps 440 and 442 a loop is established for iteratively determining 1) if a claim status response has yet been received and 2) if the timer has yet timed out. If at step 442 the timer has reached its limit, at step 444 the user may be notified that the timer timed out. Then, at steps 446 and 428, claim status request 228 may be assigned to the “No Response” category of CST categories 380 (FIG. 3J) and the request stored and/or the patient account updated with this category. At step 430 it may also be desired to ask the user if claim status request 228 should be put into the appropriate queue for resending. At step 432, if the user does not wish to queue claim status request 228 for resending, in the context of CST system 200 at step 434, processing may return to health care application 246. On the other hand, if the user wishes that claim status request 228 be resent, at step 436 the request may be sent to the appropriate request queue.

If during the countdown period a claim status response 232 is received from payer 216 at step 440, then at step 448 one of CST category responses 380 (FIG. 3J) may be assigned to the response based on information in the response. Communications sub-module 280 may be operatively configured for performing this assigning step 448. For example, if claim status response 232 includes a response category and response code as described above in connection with FIG. 2, then the response category and code may be used to determine which one of CST categories 380 should be assigned to the response. As also discussed above, the response categories and codes may be those promulgated as part of the X12N standards of the 276/277 transaction set. Examples of CST categories 380 that may be assigned to claim status request 228 include “Paid,” “Pending,” “Rejected” and “Finalized,” among others.

At step 450 the response may be stored, e.g., on database 266, and/or the patient account may be updated with the CST category of claim status response 232, as well as any information in the response that is appropriate to place in the patient account file. Some or all of the information contained in claim status response 232 may be displayed to the user at step 452, e.g., by claim status display sub-module 284. If response categories and codes are used, and these items as returned by payer 216 in claim status response are not readily identifiable by a user, e.g., the response category and code for any given response are non-word character strings, step 452 may include steps (not shown) of looking up descriptions for the character strings in response category and response code dictionaries 290, 292 and displaying the descriptions to the user.

At step 454 it may be determined whether or not further action is required for the claim corresponding to claim status response 232 just received. The determination regarding further action may be made based upon, e.g., the CST category assigned to claim status response 232 in step 448 and/or information contained in the response itself. Such further actions may include, among others, posting information contained in claim status response 232 to a follow-up list, e.g., one of follow-up lists 296 or triggering an automated event, e.g., performing an automated write-off procedure. If further action is required at step 454, at step 456 it may be determined if the further action requires human interaction or not. If the further action requires human interaction, the further actions may best be handled by posting information regarding transaction set 224 at step 458 to an appropriate follow-up list, e.g., one of follow-up lists 296, that follow-up staff or another may use as a worklist. On the other hand, if the further action does not require human interaction, at step 460 an automated follow-up task, e.g., an automated write-off process for rejected claims, may be triggered. The action of posting of a transaction set 224 to a follow-up list or the triggering of an automated follow-up task may be considered “routing” or “intelligent routing” of a claim status response 232 even though the response itself may not be sent to the corresponding follow-up list or task. Rather, only certain information from and/or about claim status response 232 may be posted or used to trigger an event. Router sub-module 282 may be operatively configured for implementing intelligent routing of claim status responses 232. After response 232 has been routed, e.g., either posted to a follow-up list or used to trigger an automated event, processing may revert from CST module 258 to health care application 246.

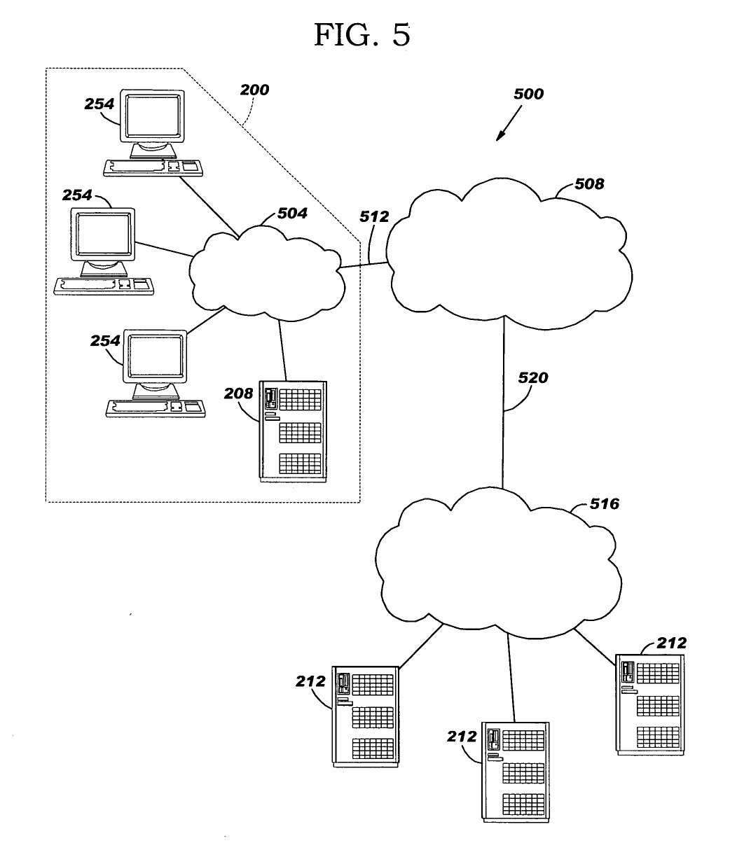

Referring to FIG. 5, and also to FIG. 2, FIG. 5 illustrates a computer system 500 in which a CST system of the present invention, e.g., CST system 200 of FIG. 2, may be implemented. As those skilled in the art will appreciate, a CST system of the present invention may be readily adapted to many other types of computer systems using only knowledge well-known in the art. In the context of CST system 200 of FIG. 2, computer system 500 may include a local area network (LAN) 504, which may be connected to a wide area network (WAN) 508 via link 512, which may in turn be connected to a global network 516, such as the Internet, via link 520. Such links 512, 520 are well-known in the art and, therefore, need not be described in any detail.

Health care provider server 208 may be directly connected to any one of LAN 504, WAN 508, global network 516 or other WAN and/or LAN (not shown) connected to the global network. Likewise, user workstations 254 used to access health care provider server 208 in order to utilize the functionality of CST system 200 may be directly connected to any one of LAN 504, WAN 508, global network 516 or other WAN and/or LAN (not shown) connected to the global network. However, in the present example, health care provider server 208 and workstations 254 are shown as being directly connected to LAN 504. This is typical of a scenario when health care server 208 is on-site relative to all of the users of CST system 200. Also typical, but not necessary, is that payer servers 212, or LANs and/or WANs (not shown) to which payers servers may be directly connected, are connected to global network 516 and not to WAN 508 or LAN 504, although in alternative embodiments one or more of the payer servers or their LANs and/or WANs could be connected to WAN 508 or LAN 504. Regardless of how computer system 500 in configured, the functioning of CST system 200 is essentially the same as described above in connection with FIGS. 2-4, generally with only the communications links, protocols etc. among the various components of the CST system differing to suit the different configurations.

Although the invention has been described and illustrated with respect to an exemplary embodiment thereof, it should be understood by those skilled in the art that the foregoing and various other changes, omissions and additions may be made therein and thereto, without parting from the spirit and scope of the present invention.

1. A method of automatically handling a claim status transaction, comprising the steps of:
a) receiving an electronic claim status response containing information relating to status of a claim; and
b) electronically routing said electronic claim status response as a function of said information.

2. A method according to claim 1, further comprising, following step a), the step of assigning a claim status transaction category based on said information.

3. A method according to claim 2, wherein step b) comprises electronically routing said electronic claim status response based on said claim status transaction category.

4. A method according to claim 3, wherein step b) includes posting said electronic claim status response to a follow-up list based on said claim status transaction category.

5. A method according to claim 3, wherein step b) includes triggering an automated follow-up task based on said claim status transaction category.

6. A method according to claim 3, wherein said electronic claim status response is a 277 response.

7. A method according to claim 1, wherein step b) includes posting said electronic claim status response to a follow-up list as a function of said information.

8. A method according to claim 1, wherein step b) includes triggering an automated follow-up task as a function of said information.

9. A method according to claim 1, wherein said electronic claim status response is a 277 response.

10. A method according to claim 1, further comprising the step of presenting a description of said status to a user.

11. A method according to claim 10, further comprising the step of looking up said description in at least one dictionary.

12. A method of automatically handling a claim status transaction, comprising the steps of:
a) assembling an electronic claim status request for a claim;
b) performing at least one check on said electronic claim status request;
c) determining if said electronic claim status request passes or fails said at least one check;
d) if said electronic claim status request fails said at least one check, assigning a claim status transaction category to said electronic claim status request.

13. A method according to claim 12, wherein said electronic claim status request corresponds to a payer and step b) includes checking if said payer is eligible to receive said electronic claim status request.

14. A method according to claim 12, wherein step b) includes querying a user if said electronic claim status request should be sent even though said claim was submitted to a payer within a predetermined number of days.

15. A method according to claim 12, wherein step b) includes querying a user if said electronic claim status request should be sent even though a similar request was submitted to a payer within a predetermined number of days.

16. A method according to claim 12, further comprising, if said electronic claim status request fails, routing said electronic claim status request to a follow-up list.

17. A method according to claim 12, further comprising, if said electronic claim status request passes said at least one check, sending said electronic claim status request to a payer.

18. A method according to claim 17, where the step of sending said electronic claim status request comprises waiting a predetermined period to receive an electronic claim status response.

19. A method according to claim 18, further comprising the step of counting down said predetermined period.

20. A method according to claim 18, further comprising, following the step of waiting, aborting the sending step.

21. A computer readable medium containing computer executable instructions implementing a method of handling a health care claim status transaction, the instructions comprising:
a) a first set of instructions for receiving an electronic health care claim status response containing information relating to status of a claim; and
b) a second set of instructions for electronically routing said electronic health care claim status response as a function of said information.

22. A computer readable medium according to claim 21, further comprising instructions for assigning a claim status transaction category based on said information.

23. A computer readable medium according to claim 22, further comprising instructions for electronically routing said electronic health care claim status response based on said claim status transaction category.

24. A computer readable medium according to claim 23, further including instructions for posting said electronic health care claim status response to a follow-up list based on said claim status category.

25. A computer readable medium according to claim 23, further including instructions for triggering an automated follow-up task based on said claim status category.

26. A computer readable medium according to claim 21, further including instructions for posting said electronic claim status response to a follow-up list as a function of said information.

27. A computer readable medium according to claim 21, further including instructions for triggering an automated follow-up task as a function of said information.

28. A computer readable medium according to claim 21, further including instructions for presenting a description of said status to a user.

29. A computer readable medium according to claim 28, further including instructions for looking up said description in at least one dictionary.

30. A system, comprising:
at least one computer containing:
a) a health care software application that provides a user with patient invoice functionality relating to at least one health care claim; and
b) a claim status transaction software module operatively configured to interface with said health care application, said claim status transaction software module comprising:
i) a first set of computer instructions for receiving an electronic health care claim status response containing information relating to status of said at least one health care claim; and
ii) a second set of computer instructions for electronically routing said electronic health care claim status response as a function of said information.

31. A system according to claim 30, wherein said claim status transaction software module further comprises computer instructions for assigning a claim status transaction category based on said information.

32. A system according to claim 31, wherein said claim status transaction software module further comprises computer instructions for electronically routing said electronic health care claim status response based on said claim status transaction category.

33. A system according to claim 32, wherein said claim status transaction software module further comprises computer instructions for posting said electronic health care claim status response to a follow-up list based on said claim status category.

34. A system according to claim 32, wherein said claim status transaction software module further comprises computer instructions for triggering an automated follow-up task based on said claim status category.

35. A system according to claim 30, wherein said claim status transaction software module further comprises computer instructions for posting said electronic claim status response to a follow-up list as a function of said information.

36. A system according to claim 30, wherein said claim status transaction software module further comprises computer instructions for triggering an automated follow-up task as a function of said information.

37. A system according to claim 30, wherein said claim status transaction software module further comprises computer instructions for presenting a description of said status to a user.

38. A system according to claim 37, further including instructions for looking up said description in at least one dictionary.
